(19) United States
(12) Patent Application Publication
(10) Pub. No.: US 2016/0260512 A1
(43) Pub. Date: Sep. 8, 2016

(54) WASTE IMMOBILIZATION METHODS AND STORAGE SYSTEMS

(71) Applicant: Savannah River Nuclear Solutions, LLC, Aiken, SC (US)

(72) Inventor: John T. Bobbitt, III, Evans, GA (US)

(21) Appl. No.: 15/044,648

(22) Filed: Feb. 16, 2016

Related U.S. Application Data
(60) Provisional application No. 62/128,570, filed on Mar. 5, 2015.

(51) Int. Cl. G21F 9/30; G21F 9/34; B09B 3/00

(52) U.S. Cl. CPC G21F 9/302; B09B 3/0025; G21F 9/34

(57) ABSTRACT

Disclosed are methods for immobilizing hazardous waste within a solid waste form and solid waste forms that can be formed according to the methods. The methods include dispersing waste materials throughout a metallic matrix material to form a particulate mixture followed by solidification of at least the metallic components of the mixture to form a solid waste form. The solidification can be carried out either incrementally in an additive manufacturing process or in bulk, but in either case, the solidification process is carried out such that waste material remains located within the solid metallic matrix essentially as deposited and there is little or no opportunity for the waste materials to separate and disperse throughout the matrix material. As such, the waste is retained within the solidified matrix essentially as deposited with no possibility for the waste to coalesce either during or following the solidification process.

### CROSS REFERENCE TO RELATED APPLICATION

This application claims filing benefit of U.S. Provisional Patent Application Ser. No. 62/128,570 having a filing date of Mar. 5, 2015, which is incorporated herein by reference for all purposes.

### STATEMENT AS TO RIGHTS TO INVENTIONS MADE UNDER FEDERALLY SPONSORED RESEARCH

This invention was made with Government support under Contract No. DE-AC09-085R22470 awarded by the United States Department of Energy. The Government has certain rights in the invention.

### BACKGROUND

Long term storage and disposal of hazardous waste presents many challenges. For instance, the waste should be maintained in a form that will prevent escape to the environment via dispersal such as leaching, gasification, vaporization, etc. Additional concerns exist for radioactive hazardous waste, and particularly for fissile waste materials. Fissile waste materials must be processed and stored so as to prevent criticality. In addition, fissile waste materials should be stored and disposed of in a fashion such that misappropriation is suitably difficult. While answering such concerns, waste treatment methods and materials also need to be as economical as possible and minimize long-term storage volume.

Current hazardous waste treatment processes include mixing the hazardous waste with a matrix material, such as a glass, cement or ceramic matrix material, followed by bulk solidification of the mix. Unfortunately, these solidification methods and materials can allow coalescing of the waste within the bulk prior to complete solidification. This leads to a high volume/low waste density form in order to minimize the density of coalesced waste at any local area within the bulk. For instance, when considering fissile materials, a worst case scenario of all fissile materials in adjacent storage canisters coalescing to a proximal volume must be considered. Waste quantities in any one canister must be held at a level such that in this worst case scenario, the quantity of fissile material in the proximal volume is still well below critical.

Other problems exist with current methods and materials as well. For instance, the matrix materials used are often brittle or can become brittle over time which can lead to fracture or crack formation under relatively little pressure. As such, these solidified waste forms require high-strength external packaging to meet minimum strength requirements. Other forms contain water which can undergo radiolysis and result in hydrogen generation. When the hydrogen is able to migrate uncontrolled through the form, it can outgas from the form which presents a flammability risk. If the hydrogen remains randomly dispersed it can lead to internal stresses which can result in cracking of the form. Additionally, alternative forms may not be difficult enough to separate the waste from the matrix for diversion of the hazardous material, and therefore may require additional physical security requirements.

What are needed in the art are methods and materials for processing and long-term storage of hazardous waste and in one embodiment, for radioactive waste materials, mixed waste materials, and in one particular embodiment fissile waste materials.

### SUMMARY

Aspects and advantages of the invention will be set forth in part in the following description, or may be obvious from the description, or may be learned through practice of the invention.

In one embodiment disclosed herein is a method for immobilizing a waste material. A method can include depositing a particulate waste material and a particulate matrix material. More specifically, the particulate waste material can include a hazardous waste and, in one embodiment a hazardous fissile waste; and the particulate matrix material can include a metal. The method also includes solidifying at least a portion of the metal by addition of energy to the deposited particulate materials. The solidification forms a solid waste form that includes a solid metallic matrix that includes the waste material dispersed within the metallic matrix.

Also disclosed are solid waste forms that can be formed according to disclosed methods. For instance, the solid waste form can include a hazardous waste dispersed throughout a solid metallic matrix material according to a predetermined pattern. The predetermined pattern can be, for example, the homogeneous dispersal of the waste material throughout the matrix or a random or regular or irregular geometric pattern of the waste material throughout the matrix. The solid waste form can optionally include other features such as an interconnected porosity throughout the waste form, an alloy comprising the metal of the matrix and a component of the hazardous waste, and/or an encapsulation surrounding the solid waste form.

These and other features, aspects and advantages of the present disclosure will become better understood with reference to the following description and appended claims.

### BRIEF DESCRIPTION OF THE FIGURES

A full and enabling disclosure of the present invention, including the best mode thereof, directed to one of ordinary skill in the art, is set forth in the specification, which makes reference to the appended figures, in which:

FIG. 1 illustrates a cross sectional view of a solid waste form formed according to an additive manufacturing process.

FIG. 2 illustrates a cross sectional view of a solid waste form formed according to an additive manufacturing process.

FIG. 3 illustrates a cross sectional view of a solid waste form formed according to an additive manufacturing process.

FIG. 4 schematically illustrates a solid waste form that includes multiple different materials.

FIG. 5 schematically illustrates a solid waste form that includes multiple different waste materials.

FIG. 6 schematically illustrates a plurality of solid waste forms having interlocking geometric shapes.

FIG. 7 schematically illustrates a plurality of solid waste forms having minimal contact between adjacent waste forms.

### DETAILED DESCRIPTION

It is to be understood by one of ordinary skill in the art that the present discussion is a description of exemplary embodiments only, and is not intended as limiting the broader aspects of the present disclosure. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure is generally directed to methods for immobilizing hazardous waste within a solid waste form and the solid waste forms that can be formed according to the methods. More specifically, the disclosed methods include the deposition of waste materials with a matrix material followed by solidification of at least some components of the deposited materials to form a solid waste form.

The components can be solidified either incrementally or in bulk, but in either case, the solidification process is carried out such that waste material remains located within the solidified matrix where deposited or with minimal migration (e.g., about 0.25 inches of migration or less during and following solidification) and as such there is no opportunity for the waste materials to separate and disperse throughout the matrix material. Accordingly, the waste is retained within the solidified matrix essentially as deposited with no possibility for the waste to coalesce either during or following the solidification process.

The matrix material can include a metal that upon solidification can form a solid metallic matrix. This can increase the overall strength of the solid waste form formed according to the process. For instance, the solid waste form can be strong enough to qualify as a special form with regard to transportation regulations. Specifically, the solid waste form can be capable of withstanding changes in temperature, pressure, humidity, shocks, loadings, vibrations, etc. during shipping and storage and there will be no hazardous material residue external to the solid waste form during or following shipping. As such, the solid waste form need not be packaged with special packaging materials designed to provide the strength that previously known solid waste forms (e.g., ceramic and concrete-based waste forms) lack. This can be of great economic benefit when shipping and storing the hazardous waste contained in the solid waste form.

Utilization of a metallic matrix can provide additional benefits as well. For instance, in one embodiment, the waste can also include a metal, and the energy addition during the solidification process can form an alloy that includes the metal of the matrix and the metal of the waste. This can further improve sequestration and immobilization of the waste in the solid waste form. In addition, when considering radioactive waste, a metal of the matrix can be selected that is an absorber of emissions from the radioactive materials. As such additional absorbers need not be added to the waste form, which can provide cost savings.

Because the waste can be locked into place within the solid waste form according to the deposition pattern of the particulate mixture and the possibility of diffusion of the waste can be negligible or non-existent, relatively high waste densities can be incorporated in the solidified waste form. In addition, the inability of waste to coalesce or agglomerate with other waste in the mixture can allow for combination of multiple different types of waste in a single waste form. For instance, a deposition process can be utilized to locate a first type of waste in particular locations throughout a waste form and a second type of waste in other locations throughout the same waste form, and the solidification process can be utilized to prevent any possible agglomeration of the two materials either during or following the solidification process. The different waste materials can thus be contained separated from one another with no possibility of combination while still combined in a single bulk waste form. Depending upon the specific nature of the waste to be processed, in one embodiment the waste materials can encompass mixed waste, i.e., waste that is comingled and mixed together prior to deposition and solidification. Combinations of mixed waste and separated waste are also encompassed. The ability to securely isolate waste within a matrix can greatly decrease the total volume necessary for long term storage and disposal of multiple waste materials.

Waste as may be treated according to the process can encompass any waste that can be dried (when necessary), solidified and formed as a particle for deposition. In general, however, the waste to be treated can be hazardous waste that requires isolation for storage and/or disposal. As utilized herein, the term “hazardous waste” generally refers to waste materials that can pose a present or potential danger to human health and/or the environment if improperly treated, stored, transported, disposed of, or otherwise managed. The term “hazardous waste” can include radionuclides, which encompass any nuclide that emits radiation, including one or more of alpha, beta, and neutron radiation. In one embodiment, the waste materials can include fissile materials, i.e., a material capable of sustaining a nuclear fission chain reaction with neutrons of any energy. In one embodiment, the waste materials can include actinides.

By way of example and without limitation, hazardous waste materials as can be processed as described herein can include the following elements or compounds thereof as well as mixtures of wastes: iron, sodium, beryllium, phosphorus, chromium, aluminum, manganese, nickel, zirconium, potassium, cesium, ruthenium, strontium, barium, technetium, rhodium, magnesium, iodine, one or more lanthanides, one or more actinides, or combinations thereof. In one particular embodiment, the waste materials can include actinide waste materials including, and without limitation plutonium and/or uranium waste materials such as one or more oxides of uranium (UO₂, U₃O₈, UO₃) and/or plutonium oxide (PuO₂).

The waste materials can be ground, milled, or otherwise processed, as necessary, to form particles of the waste materials. For example, a high-speed attritor mill utilizing milling media such as, and without limitation, zirconia (e.g., yttria-stabilized zirconia), aluminum oxide, depleted uranium, stainless steel, or ceramic milling media can be utilized to mill the waste materials.

The particles size of the waste materials is not particularly limited, and can be, e.g., about 1000 micrometers (μm) or less in average size, about 500 μm or less in average size, about 200 μm or less in average size, about 100 μm or less in average size, or about 50 μm or less in average size in some embodiments. When considering radioactive fissile materials, the preferred particle size will, of course, consider the necessity of avoiding criticality. The preferred particle size can also depend upon the specific particle deposition and solidification methods utilized, discussed further herein.

The matrix material to be combined with the waste material can include a metal or metal alloy that when solidified can provide high strength characteristics to the solidified waste form as well as provide additional benefits, depending upon the exact nature of the waste materials and the metal. As utilized herein, the term “metal” is intended to refer to both metals and metal alloys. For instance, in one embodiment, the matrix material can include stainless steel, which can not only be processed to form a high strength matrix surrounding the waste materials, but can also be alloyed with metals of a waste material to further improve immobilization of the waste. In addition, when considering the processing of fissile materials, stainless steel, and in one particular embodiment borated stainless steel, can absorb neutrons emitted from the radioactive waste and lessen or remove the necessity of the addition of other neutron absorbers such as hafnium, gadolinium, and samarium to the waste materials. In one particular embodiment, the matrix material can include austenitic stainless steel or a duplex stainless steel, though other stainless steels are likewise encompassed herein.

Of course, metals as may be incorporated in a matrix are not limited to stainless steel and other metal alloys and/or metals can be utilized in forming the matrix. Metals and metal alloys for use in the matrix material can include, without limitation, cobalt alloys, nickel alloys, iron, aluminum, neutron absorbers, and other metals as well as mixtures of metals.

The matrix material can also include poisons that can inhibit chemical separations of materials of the waste form. Poisons include elements and chemical compounds that can preferentially react with other chemicals that could dissolve the matrix material, for instance chemicals that could be utilized to dissolve the matrix material and recover the waste materials held in the matrix. Inclusion of one or more poisons in the matrix material can render such chemicals ineffective at dissolving the bulk of the matrix and prevent recovery of the waste materials held in the waste form. Possible poisons can include, without limitation, cements (e.g., mixtures of silicates and oxides including, for instance, one or more of 2CaO•SiO₂, 3CaO•SiO₂, 3CaO•Al₂O₃, 4CaO•Al₂O₃•Fe₂O₃), clay, diatomaceous earth, quarts, silica, and iron oxides.

A particulate mixture including the metal(s) and other components (if any) of the matrix can be formed according to any standard processing technique with a preferred technique generally depending upon the metal (or metal alloy) to be processed and the particle size desired. By way of example, a metal powder can be formed via communication, grinding, chemical reaction, electrolytic deposition, and so forth. In general, the particle size of the metal can be about the same as the particle size of the waste, which can improve mixing characteristics of the two and the distribution of the waste material throughout the matrix material, though this is not a requirement of the process. For instance, a metal powder to be combined with the waste material can have an average particle size of about 1000 μm or less, about 500 μm or less, about 200 μm or less, about 100 μm or less, or about 50 μm or less in some embodiments.

Blending of the particulate waste material with the particulate matrix material can be carried out in any suitable fashion and at any point in the process that can distribute the waste material throughout the matrix material with an essentially homogeneous distribution. Standard mixing devices such as drum tumblers (e.g., a V-shaped drum mixer) or shaker mixers can be utilized. Alternate device types can include static mixers such as those of the Kenics type. Impeller types can likewise vary and can include blades, screws, ploughs, etc. that can effectively sweep groups of particles through the mixing zone and distribute the waste material throughout the matrix material.

Blending can be carried out prior to deposition of the materials or during deposition of the materials prior to solidification. For instance, in one embodiment, the waste material and the matrix material can be deposited simultaneously from two different deposition heads, and blending can be carried out at this deposition, prior to solidification.

Blending of the matrix material with the waste material can also encompass additional milling or grinding of one or both of the components. In one embodiment, the waste material and the matrix material can be blended by use of a ball mill. In another embodiment, a high-energy mixer such as an attritor mill can be utilized to combine the waste material with the matrix material, for instance as a dry mixture. Blending need not be carried out with the components dry, and a slurry can be formed with the materials blended in conjunction with an aqueous vehicle. In this embodiment, the blend can be dried prior to or during solidification. For instance, the energy utilized to solidify the matrix material can initially dry the blend. Optionally, one of the materials can be deposited as a slurry, and another can be deposited dry, for instance on the top of or underneath the deposited slurry.

Because of the solidification techniques that prevent mobility of the waste within the matrix material both during and following solidification, the deposited materials can include the waste materials in relatively high concentrations. For example, the deposited materials (and the solid waste form formed of the deposited materials) can include a radioactive waste material in an amount of about 1% by weight of the mixture or greater, for instance about 3 wt. % or greater, about 5 wt. % or greater, or about 10 wt. % or greater in some embodiments. Other hazardous waste materials can likewise be included in the particulate mixture in relatively high concentrations, for instance about 12 wt. % or greater, about 15 wt. % or greater or about 20 wt. % or greater in some embodiments.

Additives can be incorporated in the waste materials and/or the matrix materials. Additives can provide benefit during processing and/or can provide benefit to the final solidified waste form. For instance, one or more poisons as discussed above can be incorporated in the waste form to prevent recovery of the waste. In one embodiment, one or more dispersants can be included in the waste material, the matrix material and/or the mixture of the two that can enhance flowability of the materials. Examples of dispersants include but are not limited to ethylene bis-stearamide, polyolefins, stearic acid, citric acid and monoisopropanol-amine.

When considering radioactive waste materials, neutron absorbers such as hafnium (e.g., HfO₂), gadolinium (e.g., Gd₂O₃), samarium (Sm₂O₃) or mixtures thereof can be incorporated in the mixture. As previously mentioned, however, in those embodiments in which stainless steel is utilized in the matrix material, the inclusion of additional neutron absorbers may not be necessary.

The waste materials can be combined with the matrix materials with the waste material distributed throughout the particulate material in a predetermined fashion. For instance, in one embodiment, the waste materials can be homogeneously distributed throughout the matrix materials in a mixture prior to deposition. If water has been incorporated during formation or mixing of the materials, the mixture can be dried prior to or during solidification. As utilized herein, the term “dry” generally refers to a material that does not include any added liquid. Thus, a dry mixture need not be completely free of all moisture and can be, for instance, at ambient humidity. A dry material is, however, to be considered to be free of bulk liquid. In those embodiments in which the mixture is dried prior to solidification, the drying can be carried out so as to maintain the desired distribution of the waste materials throughout the matrix material.

The waste material and the matrix material can be deposited and solidified so as to maintain the waste material essentially at the deposited location within the final waste form and prevent movement of the waste with respect to the matrix during and following solidification. In one embodiment, the materials can be deposited and solidified according to an additive manufacturing process. According to another embodiment, the particulate mixture can be deposited and solidified according to a hot isostatic pressing process. In another embodiment, the matrix material can first be deposited, for instance via extrusion or a wire feed, and the waste material can be separately deposited at predetermined locations and thus combined with the matrix material. For instance, the waste material can be deposited as a powder to a melt pool of the matrix material.

Additive manufacturing refers to any method for forming a three-dimensional object in which materials are deposited according to a controlled deposition and/or solidification process. The main differences between additive manufacturing processes are the types of materials to be deposited and the way the materials are deposited and solidified. Some methods extrude materials including liquids (e.g., melts or gels) and extrudable solids (e.g., clays or ceramics) to produce a layer, followed by spontaneous or controlled curing of the extrudate in the desired pattern.

According to one embodiment of the disclosed methods, the solid waste form can be created according to an additive manufacturing process in which the matrix and waste materials are deposited either together or separately in a layer followed by the application of energy and/or binders (often in a focused pattern) to join the deposited materials and form a single, solid structure having a predetermined shape. For example, a single layer can generally be on the order of about 1000 micrometers (μm) in thickness or less, about 500 μm in thickness or less, or about 100 μm in thickness or less.

Successive layers can be individually treated to solidify the deposited material prior to deposition of the succeeding layer, with each successive layer becoming adhered to the previous layer during the solidification process. Alternatively, a plurality of layers can be formed and the multiple layers of the deposited material can then be treated to solidify the deposited material.

Additive manufacturing methods encompassed can include, without limitation, selective laser sintering (SLS), direct metal laser sintering (DMLS), selective laser melting (SLM), electron beam melting (EBM), Laser Engineered Net Shaping™ (LENS®), etc.

In one embodiment, a particulate mixture including the waste material and the matrix material can be deposited to form a single area (e.g., a layer), and all or select areas of the area can then be cohered to solidify the matrix material and form a single area of the solidified waste form. In one embodiment, the waste material can likewise be cohered. For instance the waste material can cohere to adjacent particles of waste material and/or to adjacent particles of matrix material. Alternatively, the matrix material can cohere and encapsulate the particles of waste material. In one embodiment, the process of cohering the mixture can form an alloy between the metal or metal alloy of the matrix material and a metal of the waste material.

In those embodiments in which the solidification process can include melting of the waste material, the volume of waste material in the liquid phase at any one time can be small (e.g., a portion of a single or a few layers at most) and the time prior to solidification of the melt can be limited (e.g., less than about 5 seconds). As such, even in those additive manufacturing processes that include melting of the waste material, the mobility of the liquid waste material will be bound by the limited melted area, and the waste will not disperse throughout the matrix material and can remain within the matrix material essentially as deposited prior to and following solidification.

Solidification of at least the metal of a matrix material can be carried out through the focused addition of energy (e.g., laser or electron beam melting or sintering). For example, selective laser sintering can be utilized. Direct metal laser sintering is another suitable cohering technology in which a laser is used to fuse the powder grains of the matrix material in the targeted areas. The laser used in a laser sintering process can be any suitable laser such as a carbon dioxide laser. Selective laser melting is a similar process, but in this method the powder grains are fully melted rather than sintered. Thus, the final property characteristics such as crystal structure, density, porosity, etc. can differ depending upon the method used to solidify the powders, even when the materials are chemically identical.

Electron beam energy can also be utilized to solidify at least the metal of the matrix material following deposition. Electron beam manufacturing fully melts a powder, e.g., a metal or metal alloy powder, following deposition and is generally utilized in forming a fully-dense structure with high strength characteristics.

Irrespective of the particular method utilized in the additive manufacturing process, the method can generally have optimum processing parameters to produce the desired structure. These parameters can vary depending upon the specific build technique, the formation material(s), the geometry of the structure being formed, the final characteristics desired for the structure being formed, etc. Processing parameters can include both the parameters of the deposition as well as the parameters of the solidification. By way of example, processing parameters can include the rate of deposition of the particulate mixture, the temperature of the particulate mixture during or following deposition, the characteristics of the binding energy (e.g., the power of focused energy), the deposition and/or solidification conditions (e.g., temperature, pressure, humidity, etc.), the rate of solidification of the matrix material, the solidification of the waste material, the formation of an alloy between the matrix material and the waste material, and so forth.

Following solidification of a first area, a second area of materials can be deposited, the solidification process can be repeated, and the process can be repeated until the entire solid waste form is incrementally produced.

In one embodiment, it may be beneficial to incorporate porosity in the solid waste form. For example, in those embodiments in which the waste can produce a gas during storage and/or following disposal, it may be beneficial to provide a solid waste form that incorporates porosity for collection, dispersion, or release of the produced gas from the solid waste form to prevent the build-up of excess pressure in the solid waste form that could cause cracking or breakage of the solid.

Porosity within a solid waste form can be interconnected or isolated. Interconnected porosity can provide a flow path for gas to the exterior of the solid waste form (for those embodiments in which the gas is not hazardous) or alternatively to interior storage space within the solid waste form. Isolated porosity can provide interior storage for gas released from the local area. Beneficially, as additive manufacturing provides for excellent control of the characteristics of the solid waste form, the amount, location, and interconnectedness of porosity can be predetermined and controlled during the formation process.

One of the benefits of additive manufacturing is the ability to tightly control the solidification process and solidify only certain areas of a local area (e.g., a layer). This provides a route to control with high precision not only the shape of the overall solid waste form but also the materials used to form local areas of the solid waste form. For instance, in one embodiment, porosity can be formed through selective solidification of the deposited particulate mixture.

In one embodiment, porosity can be developed in an additively manufactured solid waste form by temporarily varying one or more of the processing parameters during the formation process. Through temporary alteration of one or more processing parameters, the solid waste form can include areas with lower density of deposited material that can provide porosity within the solid. Processing parameters that can be varied during formation can include the deposition rate of the particulate material, the energy level supplied during solidification, the type of energy supplied during solidification, the process temperature and/or pressure during deposition and/or solidification, and so forth.

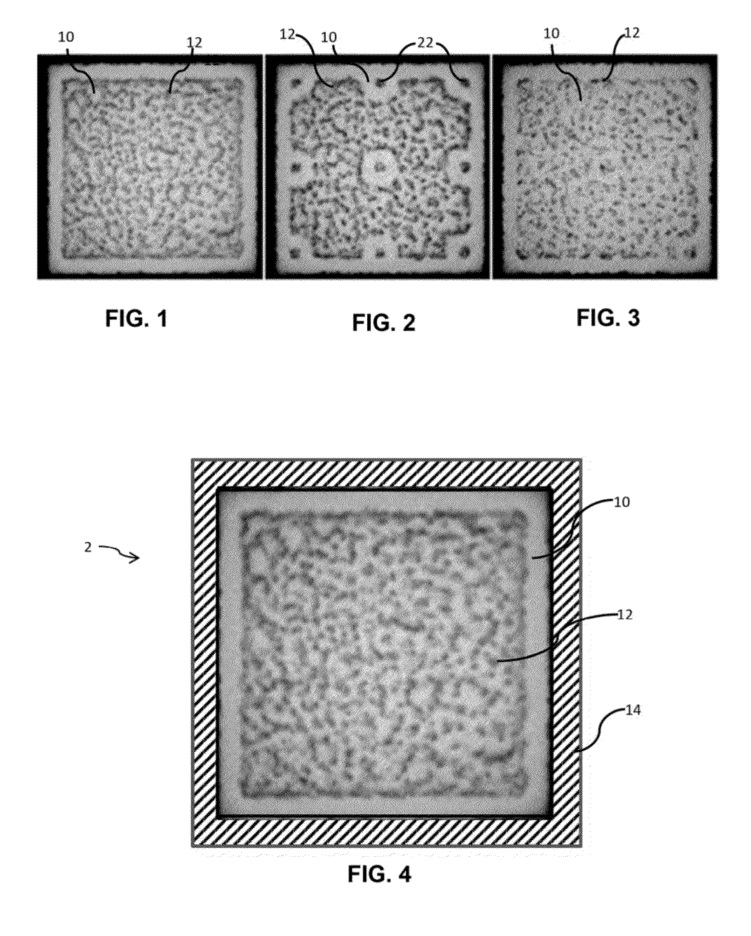

FIG. 1 illustrates a cross sectional view of an additively manufactured metal structure. In the example of FIG. 1, the metal powder was solidified by use of an electron beam. During formation the beam focus was varied. As can be seen, this variation results in porosity formation with the darker regions 12 containing little or no of the solidified formation material. In the lighter regions 10, the electron beam was highly focused and the metal powders solidified.

FIG. 3 illustrates another embodiment in which an electron beam focus was varied to provide porous areas 12 throughout the solidified metal areas 10. In this embodiment, the beam was varied out of the ideal focus less often as compared to the example of FIG. 1. As such, the material exhibits a lower porosity. Through such methods, the total porosity of the solid waste form can be tightly controlled to provide suitable porosity for gas capture or venting without excessive loss of strength of the overall structure.

Alternatively or in addition to variation in processing parameters during the solidification process, areas of the deposited powder can be simply avoided during the solidification process. That is, a focused energy (e.g., an electron beam or a laser) that is utilized to solidify at least the matrix material of the particulate mixture can be targeted with a predetermined pattern across a deposited layer, leaving a portion of the particulate mixture in the powdered form. Following deposition and solidification, this non-solidified powder can be removed leaving voids in the final solidified solid waste form. Alternatively, the non-solidified powder can be left in place. This can allow gas to flow through the porosity, and can act as filter to prevent infiltration of foreign material, such as insects, that could plug the pores.

One example of this is illustrated in FIG. 2, in which the porous areas include open shafts 22 (shown in cross section in FIG. 2) extending through the solid areas 10. The columns 22 can provide for venting to the exterior of the solid waste form, venting to an interior cavern for gas storage, or gas storage within the columns. In one embodiment, the larger columns can be interconnected to the smaller diameter porosity 12 that can be formed through relatively small variation in a process parameter during the solidification process.

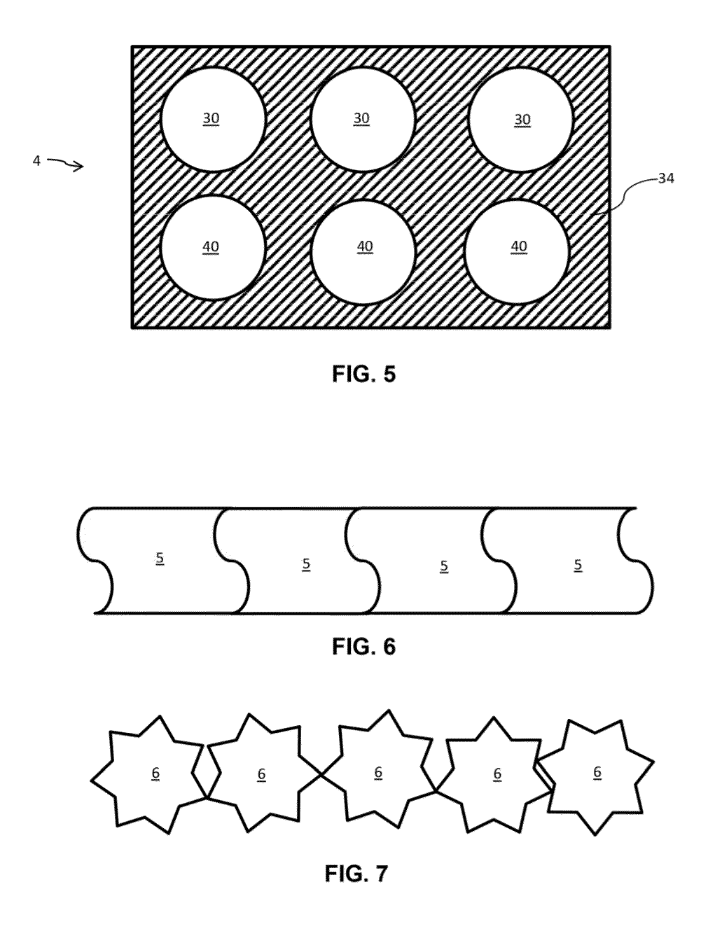

Another benefit of powder additive manufacturing processes is the ability to combine multiple materials in a single solid by use of controlled deposition of different powders. For instance, as illustrated in FIG. 4, in one embodiment, a first particulate mixture that carries a waste material can be deposited and at least the matrix material of the mixture can be solidified to form a solid material 10 with a first predetermined pattern. For example, in the embodiment of FIG. 4, the solid material 10 has been formed with a square cross section and defining porosity 12 in the interior of the solid material 10 to vent or store off-gas of the waste.

The solid waste form 2 also includes a second solid material 14 that has been deposited and solidified to encapsulate the first solid material 10. The second solid material can be, for example, a barrier material that can further strengthen the solid waste form 2 and/or prevent off gas leakage, radiation emission, etc. from the solid waste form.

The barrier material can be any suitable material. In one embodiment, a second solid material 14 utilized as a barrier material can be the matrix material alone, without the addition of the waste material dispersed therein. For example, a stainless steel powder can be deposited and solidified to encapsulate a solidified matrix/waste mixture in which the matrix material is also a stainless steel.

Two different materials can be deposited in conjunction with one another and solidified in a single step process or can be deposited and solidified sequentially. For instance, a single deposition process utilizing one or multiple deposition heads can deposit a first particulate waste material dispersed in a first area and can deposit a second particulate material (e.g., a barrier material) in a second area. The multiple areas can then be solidified in a single solidification step.

Alternatively, following deposition and solidification of a first particulate material (e.g., a particulate waste material mixed with a particulate matrix material), a second process can be carried out in which a second particulate material (e.g., a barrier material) is deposited in or around the previously solidified material, and then this second particulate material is solidified. This two-step process may be preferred in some embodiments to remove the possibility of any waste material extending into a surrounding barrier encapsulation material.

The sequestration and immobilization of waste materials in the solidified structures can also allow for multiple different waste materials to be held in a single solidified waste form, without danger of the different waste materials intermingling. This can dramatically reduce the necessary volume for storage and disposal of hazardous wastes, particularly as the wastes can also be immobilized in higher concentrations than previously thought possible, due to the inability of the waste to disperse and coalesce in the matrix either during or following solidification.

For instance, as schematically illustrated in FIG. 5, a first particulate mixture including a first waste material and a first matrix material can be solidified according to an additive manufacturing process in areas 30 of a solid waste form 4. A second particulate mixture includes a second waste material and a second matrix material can be solidified according to an additive manufacturing process in areas 40 of the solid waste form 4. In addition, a barrier material can be solidified to form an encapsulation 34 surrounding and separating the areas 30, 40 containing waste materials.

The matrix materials and barrier material can be the same or differ from one another, with preferred materials depending upon the particular waste materials to be immobilized in the solid waste form. In addition, the depositions and solidifications of the various areas can take place in a single step or in multiple steps, as desired. For instance, the encapsulation structure can be initially formed, and the waste mixtures can then be back-filled and solidified in the pre-formed areas of the encapsulation in a single step or sequentially.

Another method that can be utilized to immobilize waste material in a matrix material with little or no possibility of dispersion or coalescence of the waste either during or following solidification is a hot isostatic pressing method.

A hot isostatic pressing method can be utilized to solidify at least the metal or metal alloy of the matrix material in a particulate mixture that includes a waste material dispersed in the particulate matrix material. In one embodiment, the metals of the matrix material and of the waste material (in those embodiments in which the waste includes a metal (e.g., plutonium and/or uranium)) can be consolidated into a dense mass approaching 100 percent theoretical density by use of a hot isostatic pressing process. The resulting solidified waste form can have a uniform composition and dense microstructure providing for a waste form having high toughness, strength, fracture resistance, and thermal expansion coefficients. Such improved properties can be particularly valuable in transport, storage and disposal of hazardous waste.

A hot isostatic pressing method can be carried out under high pressures and temperatures. According to the process, the particulate mixture including the particulate waste material dispersed in the particulate matrix material that includes a metal or a metal alloy can be deposited in a container of the desired size and shape that has been sealed. The contents can then be placed under a vacuum and the container subjected to an elevated temperature and pressurized on the outside using an inert gas such as, e.g., argon to avoid chemical reaction. For example, temperatures of about 450° C. or greater, for instance from about 450° C. to about 1500° C., from about 460° C. to about 1400° C., or from about 480° C. to about 1300° C. can be utilized, with preferred temperatures generally depending upon the specific materials involved. Pressure applied can be about 50 MPa or higher, for instance, from about 50 MPa to about 300 MPa or even higher to solidify the metal of the particulate mixture. By pressurizing the container that is enclosing the particulate mixture, the selected inert gas applies pressure to the metal powder(s) at all sides and in all directions to solidify at least the matrix material of the particulate mixture without the waste material having any opportunity to disperse and coalesce either during or following solidification.

The hot isostatic pressing method can provide the solid waste form with the waste materials homogeneously dispersed throughout the waste form, with no large coalesced pockets of waste within the solid. Depending upon the specific materials involved and the solidification parameters, a hot isostatic pressing method can provide a solid waste form that incorporates porosity, for instance to allow for venting of off gases that may be generated from the contained waste.

Following formation, the solid waste form can be encapsulated within a barrier material for further isolation of the waste, as desired. For instance, a second hot isostatic pressing process can be carried out by placing the solid waste form within a metal powder and within a container as described. The second pressing process can solidify the metal powder around the solid waste form, forming a dense metal encapsulation around the solid waste form. As with an additive manufacturing process, the metal (or metal alloy) of the encapsulation can be the same as that of the matrix material or can be different, as desired.

Another benefit of the deposition and solidification techniques disclosed herein is the ability to provide a solid waste form in any desired shape. For instance, when considering an additive manufacturing process the excess powder of a layer or area that is not solidified can surround and support the solidified waste form during formation. This support can provide for the formation of more complicated structures. Similarly, when utilizing a hot isotactic pressing method, the container of the process can have any desired shape, provided the pressure can be applied equally according to the process parameters. As such, solid waste forms can be developed that can have a desired shape for instance to be more efficiently stacked or fitted together, which can remove wasted space and decrease volume requirements during transportation, storage and disposal as well as provide more stability when stacking and/or transporting solid waste forms.

Currently, solid waste forms are generally contained in cylindrical barrels or canisters. As such, there is wasted space when a plurality of the cylinders is packed together for shipping and/or storage. By use of the particulate deposition and solidification methods, the solid waste forms can have more efficient shapes, for instance cubes or more complicated geometric shapes for storage and/or transportation. In one embodiment, interlocking shapes can be formed. FIG. 6 illustrates one embodiment of a plurality of interlocking solid waste forms 5 that can be stacked together to limit wasted space between the individual forms as well as to prevent motion of the forms, for instance during transportation.

Alternatively, the shapes of the solid waste forms can be designed so as to minimize contact between adjacent waste forms, for instance to remove any possibility of criticality due to the nearness of waste in adjacent waste forms. FIG. 7 illustrates one embodiment of a plurality of solid waste forms 6 that have been designed to minimize contact between adjacent waste forms.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for immobilizing a waste material in a matrix comprising:
depositing a particulate waste material and a particulate matrix material, the particulate waste material comprising a hazardous waste, the particulate matrix material comprising a metal; and
solidifying at least a portion of the metal by addition of energy to the deposited particulate materials to form a solid waste form, the solid waste form comprising a solid metallic matrix and comprising the waste material dispersed within the solid metallic matrix, the solid metallic matrix comprising the solidified metal.

2. The method of claim 1, wherein at least one of the particulate waste material and the particulate matrix material is dry during the deposition.

3. The method of claim 1, wherein at least one of the particulate waste material and the particulate matrix material is deposited as a slurry.

4. The method of claim 1, further comprising mixing the particulate waste material with the particulate matrix material prior to depositing the particulate waste material and the particulate matrix material.

5. The method of claim 1, the step of solidifying comprising sequential addition of focused energy to a plurality of local areas, each local area containing a portion of the metal.

6. The method of claim 1, wherein the step of solidifying is carried out according to a hot isostatic pressing process.

7. The method of claim 1, wherein the hazardous waste comprises a metal, the step of solidifying comprising formation of an alloy comprising the metal of the hazardous waste and the metal of the matrix material.

8. The method of claim 1, wherein the particles of the particulate waste material and of the particulate matrix material have an average size of about 1000 micrometers or less.

9. The method of claim 1, further comprising depositing a first layer comprising a first portion of the particulate waste material and a first portion of the particulate matrix material, solidifying at least a portion of the metal of the first layer, depositing a second layer comprising a second portion of the particulate waste material and a second portion of the particulate matrix material, and solidifying at least a portion of the metal of the second layer, wherein the at least a portion of the metal of the second layer is adhered to the at least a portion of the metal of the first layer during the step of solidifying the at least a portion of the metal of the second layer.

10. The method of claim 1, further comprising incorporating porosity within the solid waste form.

11. The method of claim 1, further comprising forming a barrier that encapsulates the solid waste form, the barrier optional comprising the metal of the matrix material.

12. The method of claim 1, further comprising forming additional areas within the solid waste form, the additional areas comprising a second waste material.

13. A solid waste form comprising a hazardous waste dispersed throughout a solid metallic matrix according to a predetermined pattern.

14. The solid waste form of claim 13, wherein the predetermined pattern is a homogeneous distribution of the hazardous waste throughout the solid metallic matrix or is a random or geometric distribution of the hazardous waste throughout the solid metallic matrix.

15. The solid waste form of claim 13, wherein the hazardous waste comprises radioactive waste.

16. The solid waste form of claim 15, wherein the radioactive waste comprises one or more actinides.

17. The solid waste form of claim 13, wherein the solid waste form comprises about 1% or more waste by weight of the solid waste form.

18. The solid waste form of claim 13, the solid metallic matrix comprising a stainless steel.

19. The solid waste form of claim 13, further comprising a barrier material encapsulating the solid waste form, the barrier material optionally comprising a metal.

20. The solid waste form of claim 13, further comprising a second type of waste dispersed throughout the solid metallic matrix, the second type of waste being isolated in the solid metallic matrix at a distance from the hazardous waste of claim 13 or being mixed with the hazardous waste of claim 13.

21. The solid waste form of claim 13, the solid waste form having a predetermined shape such that multiple solid waste forms are capable of being stored with a predetermined packing density.

22. The solid waste form of claim 13, the solid waste form further comprising an additive.
